(19) United States
(12) Patent Application Publication
(10) Pub. No.: US 2023/0124187 A1
(43) Pub. Date: Apr. 20, 2023

(54) DEVICE FOR GENERATING AND STORING CARBON DIOXIDE SNOW

(71) Applicants: Messer France S.A.S, Suresnes Cedex (FR); Messer SE & Co. KGaA, Bad Soden (DE)

(72) Inventors: Emir Tebib, Lagny Le Sec (FR); Denis Beil, Duisburg (DE); Johanna Schirmacher, Willich (DE)

(73) Assignees: Messer France S.A.S., Suresnes Cedex (FR); Messer SE & Co. KGaA, Bad Soden (DE)

(21) Appl. No.: 17/907,427

(22) PCT Filed: Mar. 17, 2021
(86) PCT No.: PCT/EP2021/056874

§ 371 Date: Sep. 27, 2022

(30) Foreign Application Priority Data
Apr. 8, 2020 (DE) 10 2020 002 206.5

(51) Int. Cl. C01B 32/55

(52) U.S. Cl. CPC C01B 32/55

(57) ABSTRACT

The invention relates to a device for generating and storing carbon dioxid snow, comprising a container into which an expansion nozzle connected to a supply line for liquid carbon dioxide and a gas extraction line open, a removal device for removing carbon dioxide snow out of the container, and a measuring device for detecting the fill level of the carbon dioxide snow in the container. According to the invention, the measuring device comprises a photoelectric sensor unit which is arranged at a vertical distance to the base of the container and which comprises a light-emitting transmitter and a light-sensitive receiver.

### CROSS-REFERENCE TO RELATED APPLICATIONS

The present application is the U.S. national stage application of international application PCT/EP2021/056874 filed Mar. 17, 2021, which international application was published on Oct. 14, 2021, as International Publication WO 2021/204509 A1. The international application claims priority to German Patent Application No. 10 2020 002 206.5 filed Apr. 8, 2020.

### FIELD

The invention relates to a device for generating and storing carbon dioxide snow, comprising a container into which a snow horn connected to a supply line for liquid carbon dioxide and a gas extraction line opens, and comprising a measuring device for detecting the fill level of carbon dioxide snow in the container.

### BACKGROUND

To generate carbon dioxide snow, use is usually made of so-called snow horns. In said snow horns, liquid carbon dioxide introduced via a pressure line is expanded at an expansion nozzle, at which point the liquid carbon dioxide changes into a mixture of carbon dioxide gas and carbon dioxide snow. Since strong turbulent flows occur during the expansion of the carbon dioxide, the expansion nozzle is usually arranged in this case at the tip of a conically widening opening funnel that ensures a certain directional control of the snow-gas mixture generated.

So as to be able to at least temporarily store the carbon dioxide snow generated, the expansion nozzle for liquid carbon dioxide can also be mounted in a container. By way of example, DE 10 2017 008 488 A1 or EP 3 222 946 A1 describes a device for metering carbon dioxide snow, in the case of which an expansion nozzle for liquid carbon dioxide opens out in the interior of a container. The container is also equipped with a gas outlet that leads away from the container above the expansion nozzle. When the liquid carbon dioxide is expanded, the carbon dioxide snow formed falls toward the base of the container, while the carbon dioxide gas formed is drawn off via the gas outlet. Furthermore, the subject matter of EP 3 222 946 A1 includes a device that makes it possible, from time to time, to withdraw a defined amount of carbon dioxide snow from the container and supply it for further use, for example to cool product surfaces or to fill a refrigerant compartment of a cooling container. In order to determine whether carbon dioxide snow can be removed from the container, a sensor—not specified in any more detail in said publication—is used to identify whether a specific minimum fill level has been reached.

At present, the fill level of carbon dioxide snow in a container is usually determined using a temperature probe. As soon as the increasing amount of carbon dioxide snow in the container has reached the probe, this probe indicates a constant temperature of for example (at ambient pressure) −78.5° C., and the container can be considered to be filled at least up to the level of the probe. However, due to turbulent flows that occur during the expansion of the carbon dioxide in the container, and due to attractive interactions between the snow particles, there is the risk of a clump of snow sticking to the probe over time and falsifying the measurement result.

This could be remedied by heating the measurement point. However, this is problematic insofar as the risk of snow sticking to the probe still remains when the heating power is too low, while undesired gas-filled caverns in the snow are formed when the heating power is too high, due to the carbon dioxide that sublimates around the heater, it being possible for said caverns, as well as the heat generated by the heater, to falsify the measurement result.

### SUMMARY

The invention is therefore based on the object of providing a device for generating and storing carbon dioxide snow, in the case of which device the carbon dioxide snow fill level within the container can be determined with greater reliability.

This object is achieved by a device having the features of patent claim 1. Advantageous configurations of the invention are specified in the dependent claims.

The device according to the invention is thus distinguished by the fact that the measuring device comprises a photoelectric sensor unit that is arranged vertically spaced apart from the base of the container and that has a light-emitting transmitter and a light-sensitive receiver.

The transmitter and receiver of the photoelectric sensor unit may be accommodated in the same housing; however, this is not absolutely necessary in the context of the invention. The transmitter emits light in the direction of the interior of the container. The frequency of the light makes no difference here as long as it is ensured that the light is at least partially reflected at dry ice particles. Light in the optical or infrared range is particularly suitable. If the light inside the container impinges on a multiplicity of dry ice particles, such as those that occur in particular during the generation of snow, there is diffuse reflection and part of the light reaches the receiver. During the generation of dry ice particles, the container fills up with carbon dioxide snow. If the fill level of carbon dioxide snow surpasses the vertical position of the transmitter in the container, the receiver can no longer receive any, or virtually any, signal from the transmitter. The signal registered at the receiver therefore changes significantly. As the level of snow increases further, the signal hardly changes any further and therefore indicates to an operator that a minimum fill level is present in the container. If a number of sensor units are arranged vertically one above the other, this makes it possible to determine the fill level in the container with greater precision.

The heat emitted by the sensor unit is generally sufficient to form an air pocket in front of the sensor unit that prevents the permanent accumulation of carbon dioxide snow and thus ensures the functionality of the sensor unit. There is generally no need for an additional heating device for heating the sensor unit. It may nevertheless be advantageous to provide such a heating device especially in the case of excessive moisture in the atmosphere within the container, in order to remove or to prevent accumulations of carbon dioxide snow or water ice in the region of the sensor unit. The measurement result of the photoelectric sensor unit is influenced only marginally, if at all, by such a heating device. Furthermore, it is generally conceivable to equip the walls of the container with one or more, preferably electric, heating devices, in order to prevent cakings of carbon dioxide snow on the inner wall of the container or to be able from time to time to defrost those that have already formed, even during ongoing operation of the device.

In order to particularly reliably avoid the accumulation of snow, the transmitter and receiver of the photoelectric sensor unit should preferably be mounted in a lateral wall of the container in such a way that they are arranged with a front surface in alignment with the inner wall of the container. The front surface may in each case be an integral part of the transmitter or receiver, for instance an LED or a photodiode, said front surfaces generally being insensitive to the temperatures of approx. −78.5° C. that prevail within the container. As an alternative thereto, however, the transmitter and receiver may also be arranged behind a wall made from a transparent material, such as glass, that separates the sensor unit from the interior of the container, said wall in turn being arranged in alignment with an inner wall of the container. It is evident that the invention is not restricted to such a configuration; rather, the photoelectric sensor unit can also be positioned at other locations. By way of example, the transmitter and/or receiver can be mounted inside a channel in the wall of the container, with the respective front surfaces being arranged set back from the inner surface of the container in order to protect the components.

In order to enable a more exact determination of the fill level in the container, in an advantageous configuration of the invention a plurality of photoelectric sensor units are arranged vertically one above the other and spaced apart from one another.

In a particularly preferred embodiment of the invention, the device has a removal device for removing carbon dioxide snow from the container. Said removal device is equipped with means that permit the removal of a defined amount of carbon dioxide snow from the container at regular time intervals. By way of example, these means are a separating device that, at regular time intervals, separates a section of the container filled with carbon dioxide snow from the rest of the container and that cooperates with a push element that, after the separation, expels the carbon dioxide snow in this section of the container. Such a removal device is described for example in EP 3 222 946 A1. However, the means may also for example be a rotary feeder. The removal device is preferably designed in such a way that, in rapid succession, for example at time intervals between 1 s and 30 s, a defined amount of carbon dioxide snow can be discharged or expelled from the container. The determination of the fill level according to the invention indicates that there is an amount of carbon dioxide snow present in the container that is sufficient in each case for the regular removal.

The photoelectric sensor unit preferably has a data connection to a control unit, by means of which the inflow of liquid carbon dioxide in the supply line and/or the removal of carbon dioxide from the container at the removal device can be controlled depending on a detected fill level of carbon dioxide snow in the container. In this way, the supply of liquid carbon dioxide and/or the removal of carbon dioxide snow from the container can be controlled with great reliability automatically in accordance with a specified program and therefore carried out with high efficiency.

### BRIEF DESCRIPTION OF THE DRAWING

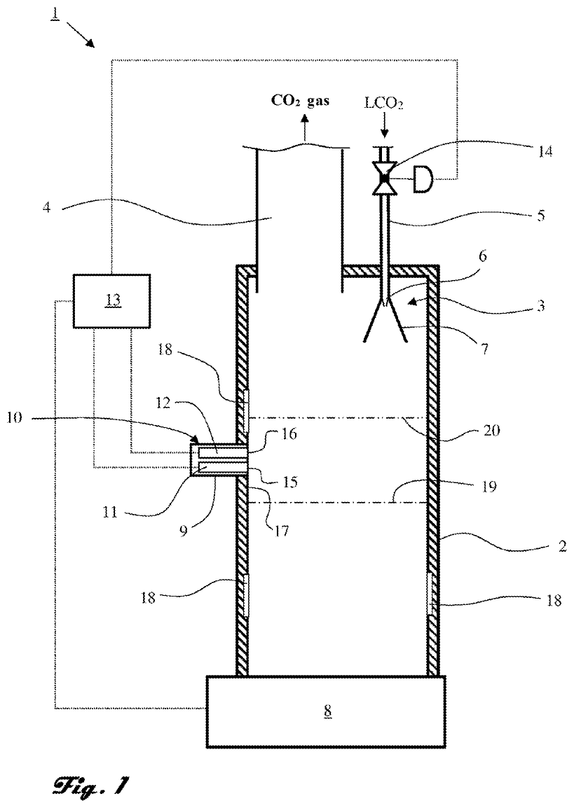

An exemplary embodiment of the invention shall be discussed in more detail on the basis of the drawing. The single drawing (FIG. 1) schematically shows a device according to the invention in longitudinal section.

### DETAILED DESCRIPTION

The device 1 shown in FIG. 1 comprises a thermally well-insulated container 2 in the form of an upright cylinder having for example a rectangular cross section, into the upper end face—seen geodetically—of which open a snow horn 3 and a gas extraction line 4. The snow horn 3 is connected to a supply line 5 for liquid carbon dioxide that in turn is connected to a tank (not shown here) in which the carbon dioxide is stocked at a pressure of for example 15 bar. The snow horn 3 comprises an expansion nozzle 6 that also forms the end of the supply line 5, and a diffuser 7 that projects into the interior of the container 2. Arranged at the base of the container 2 is a removal device 8 (not discussed in any more detail here) for removing carbon dioxide snow. By way of example, said removal device is a removal device that permits the removal of defined amounts of carbon dioxide snow at regular time intervals, as described for example in EP 3 222 946 A1 or WO 2017/167620 A1, to which reference is expressly made here. By way of example, the removal device 8 is configured in such a way that, during operation thereof, an amount of carbon dioxide snow that is the same in each case is expelled from the container 2 at time intervals, that are the same in each case, of between 1 s and 30 s, for example every 5 s to 10 s.

A photoelectric sensor unit 10 is arranged in a side wall of the container 2, vertically spaced apart from the base of the container 2. The photoelectric sensor unit 10 comprises a transmitter 11 and a receiver 12 that, in the exemplary embodiment, are accommodated in a common housing 9. The transmitter 11 is able to emit light of a specific frequency or of a specific frequency range, for example a frequency or a frequency range in the optical or infrared spectrum. The receiver is able to detect light of the same frequency or of the same frequency range and convert it into an electronic signal. The transmitter 11 and receiver 12 have a data connection to a control unit 13, from which the emission of light at the transmitter 11 can be prompted and in which electronic data from the receiver 12 can be processed. The control unit 13 also has a data connection to the removal device 8 and to a valve 14 in the supply line 5 by means of which the inflow of liquid carbon dioxide through the supply line 5 can be controlled in accordance with a control command transmitted by the control unit 13 and be adjusted for example to the amount of carbon dioxide snow to be removed from the container 2 per unit of time.

The sensor unit 10 is installed in the wall of the container 2 in such a way that a front surface 15, 16 of the transmitter 11 and receiver 12 is in each case essentially flush with the inner wall 17 of the container 2. The front surfaces 15, 16 may be part of the respective electronic component, that is to say the transmitter 11 or receiver 12, itself, or may be formed by a pane made of a transparent material (not shown here) that separates the sensor unit 10 from the interior of the container 2.

Electric heating elements 18 mounted in the inner wall 17 of the container 2 prevent carbon dioxide snow from caking on the inner wall 17. In order to ensure the functionality of the sensor unit 10, it is advisable to also provide such heating elements 18 in the vicinity of the sensor unit 10.

During operation of the device 1, liquid carbon dioxide at a pressure of for example 15 bar is introduced via the supply line 5 and expanded at the expansion nozzle 6. The liquid carbon dioxide changes here into a mixture of carbon dioxide gas and carbon dioxide snow. While the carbon dioxide gas is discharged via the gas extraction line 4, the snow generated falls downward in the container 2 and gradually fills the container 2 from the bottom upward. At the same time as the supply of carbon dioxide, the transmitter 11 is prompted by the control unit 13 to emit light into the interior of the container 2.

Whilst the fill level of the carbon dioxide snow collecting in the container 2 has not yet reached the level of the sensor unit 10, that is to say for example the container is only filled up to a first fill level 19, there is a turbulently flowing mixture of carbon dioxide snow and carbon dioxide gas at the level of the sensor unit 10 while the carbon dioxide is being supplied. Light emitted by the transmitter 11 into the interior of the container 2 is diffusely reflected by this mixture and a small portion thereof is captured by the receiver 12. The receiver 12 sends a corresponding signal to the control unit 13, said signal indicating to said control unit that the fill level of the snow has not yet reached the level of the sensor unit 10. However, if the fill level of the carbon dioxide snow in the container 2 surpasses the level of the sensor unit 10, that is to say for example it is at a second fill level 20, the light emitted by the transmitter 11 is no longer able to penetrate the layer of snow immediately in front of the transmitter 11 and only very little, if any, thereof reaches the receiver 12. A corresponding electronic signal is output by the receiver 12 to the control unit 13, said signal prompting said control unit, for instance in accordance with a specified program, to output further control commands, for example to close or throttle the valve 14 in the supply line 5 and/or to activate the removal device 8 to remove carbon dioxide.

### LIST OF REFERENCE SIGNS:

1 Device

2 Container

3 Snow horn

4 Gas extraction line

5 Supply line for liquid carbon dioxide

6 Expansion nozzle

7 Diffuser

8 Removal device

9 Housing

10 Photoelectric sensor unit

11 Transmitter

12 Receiver

13 Control unit

14 Valve

15 Front surface (of the transmitter)

16 Front surface (of the receiver)

17 Inner wall

18 Heating element

19 First fill level

20 Second fill level

1. A device for generating and storing carbon dioxide snow, the device comprising:
a container into which a snow horn connected to a supply line for liquid carbon dioxide and a gas extraction line opens; and
a measuring device for detecting the fill level of carbon dioxide snow in the container;
wherein the measuring device comprises a photoelectric sensor unit that is arranged vertically spaced apart from the base of the container and that has a light-emitting transmitter and a light-sensitive receiver.

2. The device as claimed in claim 1, wherein the transmitter and receiver of the photoelectric sensor unit are arranged in a common housing.

3. The device as claimed in claim 1, wherein the photoelectric sensor unit operates using light in the optical or infrared frequency range.

4. The device as claimed in claim 1, wherein the transmitter and receiver of the photoelectric sensor unit are arranged in a lateral wall of the container in such a way that the transmitter and receiver are arranged with a front surface in alignment with an inner wall of the container.

5. The device as claimed in claim 1, wherein a plurality of photoelectric sensor units are arranged vertically spaced apart from one another in the container.

6. The device as claimed claim 1, further comprising a removal device that has means for removing a defined amount of carbon dioxide snow from the container at regular time intervals.

7. The device as claimed in claim 6, wherein the photoelectric sensor unit has a data connection to a control unit, by means of which the inflow of liquid carbon dioxide in the supply line and/or the removal of carbon dioxide from the container at the removal device can be controlled depending on a detected fill level of carbon dioxide snow in the container.
